(19) United States
(12) Patent Application Publication
(10) Pub. No.: US 2006/0095574 A1
(43) Pub. Date: May 4, 2006

(54) Software architecture for out-of-band discovery in UPnP

(75) Inventors: Vlad Stirbu, Tampere (FI); Sampo Sovio, Riihimaki (FI); Philip Ginzboorg, Espoo (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/979,011

(22) Filed: Nov. 1, 2004

(51) Int. Cl. G06F 15/16

(52) U.S. Cl. 709/227

(57) ABSTRACT

A system, method, electronic device, module, and computer code product for communicating service information between an electronic device and a remote control point using an out-of-band discovery mechanism. An electronic device includes a memory unit, a processor operatively connected to the memory unit, and a data communication link for enabling communication within a network. The memory unit includes computer code for using an out-of-band discovery mechanism to provide service information to a remote control point through the data communication link.

### FIELD OF THE INVENTION

The present invention relates generally to Universal Plug and Play (UPnP) technology. More particularly, the present invention relates to UPnP device architecture with additional out-of-band discovery mechanisms.

### BACKGROUND OF THE INVENTION

UPnP technology defines an architecture for pervasive peer-to-peer network connectivity of intelligent appliances, wireless devices, and personal computers of all form factors. UPnP technology is designed to bring easy-to-use, flexible, standards-based connectivity to ad hoc or unmanaged networks whether in the home, in a small business, public spaces, or attached to the Internet. UPnP technology provides a distributed, open networking architecture that leverages Transmission Control Protocol/Internet Protocol (TCP/IP) and Web technologies to enable seamless proximity networking in addition to control and data transfer among networked devices.

UPnP Device Architecture (UDA) is designed to support zero-configuration, “invisible” networking, and automatic discovery for a breadth of device categories from a wide range of vendors. With UDA, a device can dynamically join a network, obtain an IP address, convey its capabilities, and learn about the presence and capabilities of other devices.

UDA describes the steps that are required in order to have a UPnP device/service or control point usable within the UPnP network. The first step, referred to as “Addressing” or “IP Addressing,” is where the device acquires an IP address from the Dynamic Host Control Protocol (DHCP) server or via Auto-IP. The second step is referred to as “Discovery,” where control points search for services or where devices/services are advertised into the UPnP network. The third step is referred to as “Description,” where the control points fetch description documents.

The three steps identified above need to occur in the exact order described above. Other steps, such as Controlling, Eventing and Presentation, do not have such strict requirements as the first three steps.

There are some scenarios where the traditional UPnP approach runs into usability problems due to the Addressing and Discovery steps, which either take too long or where the user has to perform some user interface (UI) actions in order to shorten the discovery time. One such scenario occurs when there are two users that want to quickly start a number of UPnP applications by simply touching the respective devices.

### SUMMARY OF THE INVENTION

Embodiments of the invention comprise including additional out-of-band discovery mechanisms in the UPnP device architecture. In one embodiment of the invention, the same single service discovery protocol (SSDP) messages as defined in UPnP are used, but instead of using multicast UDP as transport, a location-limited channel is used.

One embodiment of the invention comprises a computer code product including computer code for providing an out-of-band discovery mechanism on an electronic and computer code for communication service information between the electronic device and a remote control point on the out-of-band discovery mechanism. The location limited channel can comprise any of channels, such as an infrared data association channel or a radio frequency identification channel to name a few. In one embodiment, the computer code for communication service information can comprise code for using the out-of-band discovery mechanism to transmit a service advertisement to the remote control point. In addition, the computer code can be included for using the out-of-ban discovery mechanism to receive a service query from the remote control point, and using the out-of-band discovery mechanism to respond to the service query by providing a service response to the remote control point.

Other embodiments of the invention comprise electronic devices and modules comprising a memory unit, a processor operatively connected to the memory unit, and a data communication link for enabling communication within a network, wherein the memory unit includes computer code for using an out-of-band discovery mechanism to provide service information to a remote control point through the data communication link.

One embodiment of a system according to the invention can include a control point device and an electronic device in communication with the control point device. One embodiment of a method according to the invention can include providing an electronic device, providing an out-of-band discovery mechanism with the electronic device; and communication service information between the electronic device and a remote control point on the out-of-band discovery mechanism.

The present invention provides for a number of distinct advantages over conventional systems. The present invention improves the usability of electronic devices in situations where users want to start applications very quickly without having to use the user interface too extensively. This can be particularly useful for mobile/handheld devices that have very limited user interfaces yet are still used in peer-to-peer applications. The invention can be easily implemented in devices such as mobile telephones that have an IP interface with UPnP support and a location limited channel, such as IrDA, RFID, etc. Additionally, the out-of-band discovery mechanism of the present invention also inherits the security provided by the respective location-limited channel.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a UPnP protocol stack according to one embodiment of the present invention;

FIG. 2 is representation of a UPnP software stack with SSDP PI as an out-of-band discovery mechanism;

FIG. 3 is a representation of a service advertisement using the out-of-band discovery mechanism;

FIG. 4 is a representation of a service query using the out-of-band discovery mechanism;

FIG. 5 is an overview diagram of a system according to an embodiment of the present invention;

FIG. 6 is a perspective view of a mobile telephone that can be used in the implementation of the present invention;

FIG. 7 is a schematic representation of the telephone circuitry of the mobile telephone of FIG. 6.

### DETAILED DESCRIPTION OF THE PREFERRED EMBODIMENTS

The present invention involves the inclusion of additional out-of-band discovery protocols/mechanisms in the UPnP device architecture. The out-of-band protocol needs to comply with the simple service discovery protocol (SSDP) formats and SSDP application program interface (API) in order to plug seamlessly into the UPnP software stack.

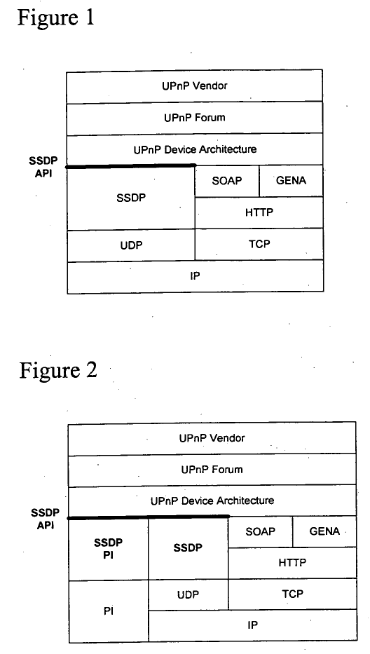

FIG. 1 is a representation of the UPnP protocol stack as specified by the UPnP device architecture. According to this stack, all of the protocols run on top of the IP.

FIG. 2 describes the protocol stack for the UPnP protocol stack enhanced with SSDP proximity initialization (PI) as an out-of-band discovery protocol. SSDP PI uses the same message payloads as the UPnP SSDP. Instead of using UDP as a transport protocol, however, it uses the location limited channels provided by the PI, including, but not limited to IrDA, RFID, etc.

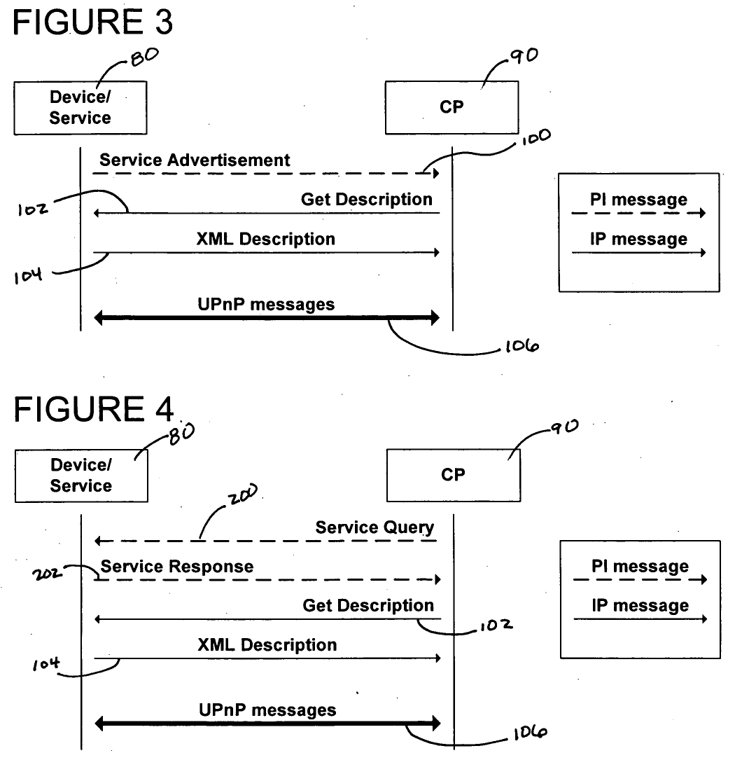

The operation of an electronic device according the principles of the present invention is generally as follows. For service advertisements and as represented in FIG. 3, an electronic device 80 that hosts the service, transmits over the location-limited channel a “Service Advertisement” message 100 containing a service advertisement. The payload in the “Service Advertisement” message 100 is the same as for a standard UPnP SSDP message:

NOTIFY * HTTP/1.1

HOST: 239.255.255.250:1900

CACHE-CONTROL: max-age=seconds until advertisement expires

LOCATION: URL for UPnP description for root device

NT: search target

NTS: ssdp:alive

SERVER: OS/version UPnP/1.0 product/version

USN: advertisement UUID

A control point device 90 that hosts the control point receives the “Service Advertisement” message 100 over the location-limited channel and continues the exchange using standard UPnP messages. For example, the control point device 90 can transmit a “Get Description” message 102, after which the electronic device 80 can respond with a “XML Description” message 104. UPnP messages 106 can also flow between the electronic device 80 and the control point device 90.

An example of a service query according to one embodiment of the present invention is represented in FIG. 4. The control point device 90 that hosts the UPnP control point sends a service query message 200 over the location-limited channel. The payload of this message is the same as for a standard UPnP SSDP message:

M-SEARCH * HTTP/1.1

HOST: 239.255.255.250:1900

MAN: “ssdp:discover”

MX: seconds to delay response

ST: search target

The electronic device 80 that hosts the UPnP Service responds also over the location-limited channel with a service response message 202 with the same payload as a standard UPnP SSDP message:

HTTP/1.1 200 OK

CACHE-CONTROL: max-age=seconds until advertisement expires

DATE: when response was generated

EXT:

LOCATION: URL for UPnP description for root device

SERVER: OS/version UPnP/1.0 product/version

ST: search target

USN: advertisement UUID

After the service response message, the devices continue the exchange using standard UPnP messages. For example, the control point device 90 can transmit a “Get Description” message 102, after which the electronic device 80 can respond with a “XML Description” message 104. UPnP messages 106 can also flow between the electronic device 80 and the control point device 90. Computer software code can be used to implement these steps.

If a device has UPnP support and an interface that supports the location limited channel functionality, then the device is capable of implementing the present invention. UPnP traffic is analyzed in order to detect the use of the invention.

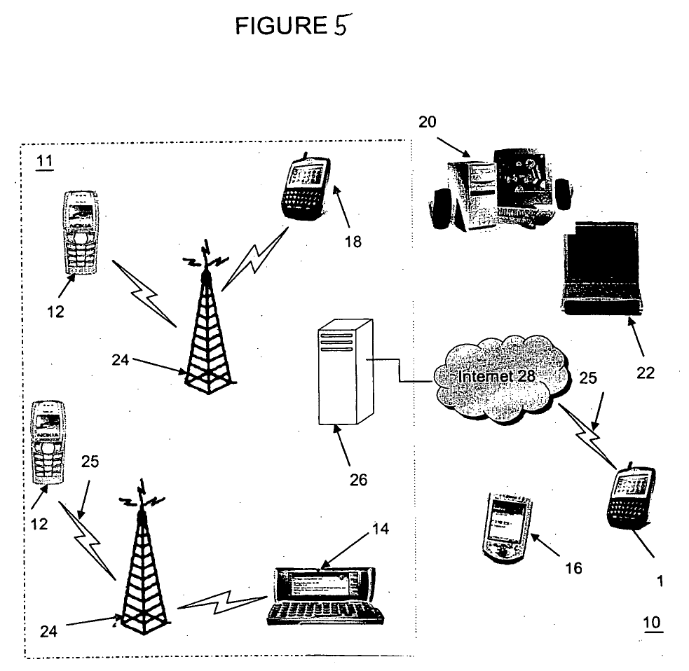

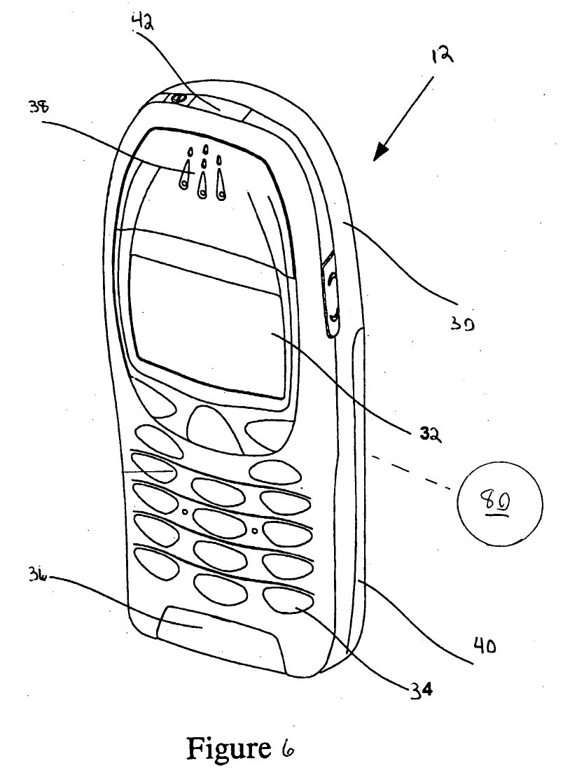

FIG. 5 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

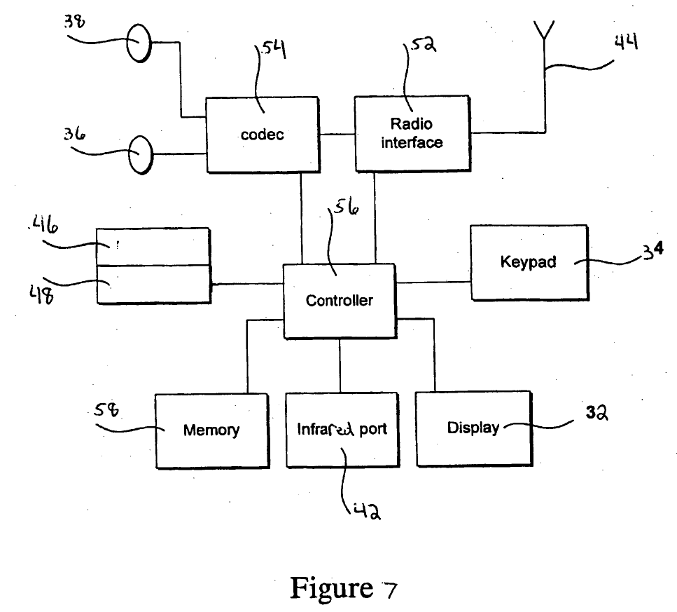

FIGS. 6 and 7 show one representative mobile telephone 12 according to one embodiment of the invention. It should be understood, however, that the present invention is not intended to be limited to one particular type of mobile telephone 12 or other electronic device. The mobile telephone 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, coded circuitry 54, a controller 56, such as a processor, and a memory 58. Individual circuits and elements are all of a type well known in the art, for example in the Nokia range of mobile telephones.

While several embodiments have been shown and described herein, it should be understood that changes and modifications can be made to the invention without departing from the invention in its broader aspects. For example, but without limitation, the present invention can be used in conjunction with a variety of electronic devices. Various features of the invention are defined in the following claims:

What is claimed is:

1. An electronic device, comprising:
a memory unit;
a processor operatively connected to the memory unit; and
a data communication link for enabling communication within a network,
wherein the memory unit includes computer code for using an out-of-band discovery mechanism to provide service information to a remote control point through the data communication link.

2. The electronic device of claim 1, wherein the out-of-band discovery mechanism comprises a simple service discovery protocol including a location-limited channel.

3. The electronic device of claim 2, wherein the location limited channel comprises an infrared data association channel.

4. The electronic device of claim 2, wherein the location limited channel comprises a radio frequency identification channel.

5. The electronic device of claim 1, wherein the out-of-band discovery mechanism transmits a service advertisement to the remote control point.

6. The electronic device of claim 1, wherein the out-of-band discovery mechanism is configured to receive a service query from the remote control point, and wherein the out-of-band discovery mechanism responds to the service query by providing a service response to the remote control point.

7. A system of providing communication within a network, comprising:
a control point device; and
an electronic device in communication with the control point device, the electronic device including:
a memory unit,
a processor operatively connected to the memory unit, and
a data communication link for enabling communication within a network,
wherein the memory unit includes computer code for using an out-of-band discovery mechanism to provide service information to the control point device through the data communication link.

8. The system of claim 7, wherein the out-of-band discovery mechanism comprises a simple service discovery protocol including a location-limited channel.

9. The system of claim 8, wherein the location limited channel comprises an infrared data association channel.

10. The system of claim 8, wherein the location limited channel comprises a radio frequency identification channel.

11. The system of claim 7, wherein the out-of-band discovery mechanism transmits a service advertisement to the control point device.

12. The system of claim 7, wherein the out-of-band discovery mechanism is configured to receive a service query from the control point device, and wherein the out-of-band discovery mechanism responds to the service query by providing a service response to the control point device.

13. A module for use with an electronic device, comprising:
a memory unit;
a processor operatively connected to the memory unit; and
a data communication link for enabling communication within a network,
wherein the memory unit includes computer code for using an out-of-band discovery mechanism to provide service information to a remote control point through the data communication link.

14. The module of claim 13, wherein the out-of-band discovery mechanism comprises a simple service discovery protocol including a location-limited channel.

15. The module of claim 14, wherein the location limited channel comprises an infrared data association channel.

16. The module of claim 14, wherein the location limited channel comprises a radio frequency identification channel.

17. The module of claim 13, wherein the out-of-band discovery mechanism transmits a service advertisement to the remote control point.

18. The module of claim 13, wherein the out-of-band discovery mechanism is configured to receive a service query from the remote control point, and wherein the out-of-band discovery mechanism responds to the service query by providing a service response to the remote control point.

19. A method of providing out-of-band discovery within a network, comprising:
providing an electronic device comprising:
a memory unit,
a processor operatively connected to the memory unit, and
a data communication link for enabling communication within the network,
providing an out-of-band discovery mechanism with the electronic device; and
communicating service information between the electronic device and a remote control point on the out-of-band discovery mechanism.

20. The method of claim 19, wherein the out-of-band discovery mechanism comprises a simple service discovery protocol including a location-limited channel.

21. The method of claim 20, wherein the location limited channel comprises an infrared data association channel.

22. The method of claim 20, wherein the location limited channel comprises a radio frequency identification channel.

23. The method of claim 19, wherein communicating service information comprises using the out-of-band discovery mechanism to transmit a service advertisement to the remote control point.

24. The method of claim 19, wherein communicating service information comprises:
using the out-of-band discovery mechanism to receive a service query from the remote control point, and
using the out-of-band discovery mechanism to respond to the service query by providing a service response to the remote control point.

25. A computer program product, comprising
computer code for providing an out-of-band discovery mechanism on an electronic device; and
computer code for communicating service information between the electronic device and a remote control point on the out-of-band discovery mechanism.

26. The computer program product of claim 25, wherein the out-of-band discovery mechanism comprises a simple service discovery protocol including a location-limited channel.

27. The computer program product of claim 26, wherein the location limited channel comprises an infrared data association channel.

28. The computer program product of claim 26, wherein the location limited channel comprises a radio frequency identification channel.

29. The computer program product of claim 25, wherein the computer code for communicating service information comprises code for using the out-of-band discovery mechanism to transmit a service advertisement to the remote control point.

30. The computer program product of claim 25, wherein the computer code for communicating service information comprises:
using the out-of-band discovery mechanism to receive a service query from the remote control point, and
using the out-of-band discovery mechanism to respond to the service query by providing a service response to the remote control point.
